(19) United States
(12) Patent Application Publication
(10) Pub. No.: US 2011/0023910 A1
(43) Pub. Date: Feb. 3, 2011

(54) ENERGY-OPTIMIZED MACHINE CONTROL SYSTEM FOR CLEANING APPARATUSES

(76) Inventor: Juergen DIRSCHUS, Schutterwald (DE)

Correspondence Address: Muncy, Geissler, Olds & Lowe, PLLC, 4000 Legato Road, Suite 310, FAIRFAX, VA, 22033, US

(21) Appl. No.: 12/847,437

(22) Filed: Jul. 30, 2010

(30) Foreign Application Priority Data
Jul. 30, 2009 (DE) DE102009035668.1

(51) Int. Cl. B08B 3/00

(52) U.S. Cl. 134/18; 134/56 D

(57) ABSTRACT

A cleaning apparatus for cleaning items to be cleaned is provided. The cleaning apparatus comprises at least two loads. The cleaning apparatus has a modular control system, which comprises a machine control system and at least one contactless control element. The machine control system is set up to perform at least one cleaning program. The contactless control element is set up to supply at least one of the loads with energy on a variable basis. The machine control system is set up to provide at least two different actuation strategies for the cleaning apparatus. Each actuation strategy comprises information about required energies for the loads. The machine control system is set up to transmit information about the required energies for the associated loads to the contactless control element via at least one bus system in line with a selected actuation strategy. The contactless control element is set up to apply the respective required energy to at least one associated load.

This nonprovisional application claims priority under 35 U.S.C. §119(a) to German Patent Application No. DE 102009035668.1-32, which was filed in Germany on Jul. 30, 2009, and which is herein incorporated by reference.

### BACKGROUND OF THE INVENTION

1. Field of the Invention

The invention relates to a cleaning apparatus for cleaning items to be cleaned and also to a method for cleaning items to be cleaned. Such cleaning apparatuses and methods are used particularly in the area of commercial dishwashing technology, for example in single-chamber or multi-chamber dishwashers. Commercial dishwashers of this kind are used particularly in large kitchens, for example in company canteens, schools, hospitals, care facilities, authorities or similar facilities in which large amounts of tableware need to be cleaned within a short time. Other fields of use are also fundamentally possible, however, for example fields of use in domestic dishwashing technology or fields of use for cleaning other kinds of items to be cleaned, for example, medical ware, machine parts, containers or similar articles.

2. Description of the Background Art

Cleaning apparatuses are known from various fields of natural sciences, engineering, medical engineering or daily life. In the text which follows, reference is made particularly to commercial dishwashing technology without thereby limiting possible other fields of use for the described invention.

In commercial dishwashing technology, tableware is usually cleaned in single-chamber or multi-chamber dishwashers. Commercial dishwashers are usually distinguished in that at least two different tanks are provided for cleaning liquids in which the cleaning liquids can be conditioned at the same time, for example can be brought to the correct temperature and/or handled in another way at the same time. In contrast to domestic dishwashers, which usually have only one tank, such a multi-tank system results in a considerable time saving.

However, a significant problem for commercial dishwashers is in many cases the not inconsiderable energy consumption of such systems. This problem is described in, for example, DE 10 2004 046 758 A1, which corresponds to U.S. Publication No. 2009/0151750, and which is incorporated herein by reference. There are thus a large number of loads within the dishwashers which need to be supplied with energy, such as tank heaters, pumps, blowers, continuous-flow heaters, transport motors or other loads.

Various aspects need to be considered when using electrical energy for cleaning apparatuses. Firstly, the energy consumption can be regarded as a resource which needs to be used as sparingly as possible. Secondly, a certain energy consumption is usually necessary, for example, in order to achieve a desired disinfecting action on the basis of the application of heat to the items to be cleaned. In addition, it should be borne in mind that the cleaning apparatuses usually have a connection value which cannot be exceeded overall. In order to be able to transport the required energy, it is necessary for connections and lines to be designed for the maximum requirement, for example. This concerns both machine-internal lines and connections provided on site. The individual functional units of the cleaning apparatus, such as tanks, clear rinsing or drying, or their loads are usually equipped firstly with motor power and secondly with heating power. Other kinds of power may also be necessary. The concurrence of the loads and their nominal value is used to calculate the total connection value of the cleaning apparatus. This nominal value and further constraints, such as accumulation, ambient temperature and distance, are usually used for designing the connecting line. The higher the AC side current, the higher the provision costs for the operator, both for providing energy and for providing the connecting line.

DE 10 2004 046 758 A1 proposes a method and an apparatus in which a group of electrical load elements in a dishwasher is assigned a maximum total electrical power. In this case, each electrical load element in this group is assigned at least two power levels. In a requirement ascertainment step, an optimum combination of power levels is chosen on the basis of an operating state of the dishwasher, the chosen power level having been customized, for each load element, to the power requirement of the load element in the operating state of the dishwasher. The total power of all load elements does not exceed the total electrical power in this case.

DE 10 2007 032 053 A1 discloses an apparatus and method for regulating the power consumption of an electrical appliance. The apparatus comprises a learning device and a control device. The learning device captures data relating to the use of the electrical appliance, and evaluates said data, over a particular period. The control device influences the operation of the electrical appliance on the basis of the data evaluation.

These known methods and apparatuses already bring about a considerable improvement in the energy management of complex machines. Nevertheless, there is a significant potential for improvement, since conventional methods and apparatuses are comparatively inflexible in practice. Thus, by way of example, a conventional system may require a complete reconfiguration of the energy management as soon as the basic design of the cleaning apparatus is changed. This change may simply involve the addition of a single load. In addition, the described methods and apparatuses are usually incapable of reacting flexibly to externally prescribed influences, for example external control by an energy management system or incorporation into such an energy management system, for example an energy management system in a hospital. Since complex energy management systems of this kind, which usually take account of a large number of individual machines, may encounter a confusingly large number of possible demands on the energy management of the individual machines, a machine control system having a firmly prescribed number of power levels is usually unsuitable for reacting in an appropriate manner to the large number of possible demands.

### SUMMARY OF THE INVENTION

It is therefore an object of the present invention to provide a cleaning apparatus and a method for cleaning items to be cleaned which avoids the drawbacks of known methods and apparatuses. In particular, the aim is to provide flexible energy management which can also be incorporated into complex energy management systems, for example in hospitals or other relatively large facilities.

A cleaning apparatus for cleaning items to be cleaned is proposed. In principle, in this context, as outlined above, the items to be cleaned may be any articles which need to be cleaned. Without limiting further possible embodiments, the invention is described below with reference to a preferred application, namely application in the area of dishwashing technology. Accordingly, the items to be cleaned may comprise tableware, that is to say articles which are used for the preparation or presentation of food and/or beverages and/or may come into indirect or direct contact with food and/or beverages. In particular, the cleaning apparatus may therefore be a dishwasher, particularly a commercial dishwasher, particularly a single-chamber or multi-chamber dishwasher. The cleaning apparatus may be designed for cleaning and/or disinfecting the items to be cleaned and may accordingly be designed to apply at least one cleaning fluid to the items to be cleaned, for example a liquid and/or a vapour. Other kinds of cleaning apparatuses are also fundamentally possible however, for example cleaning apparatuses in which merely disinfection takes place, for example under the action of heat. Various embodiments are possible.

The cleaning apparatus can comprise at least two loads. In this context a load is intended to be understood to mean any element which is required for the operation of the cleaning apparatus and which needs to have an energy, particularly an electrical energy and/or a thermal energy, applied to it. Various exemplary embodiments of loads are explained in more detail below.

The cleaning apparatus can comprise at least one modular control system. In this context, a control system is intended to be understood to mean an electrical, electronic or electromechanical device which is set up to influence at least one cleaning process in the cleaning apparatus. In particular, one or more cleaning programmes may be able to be performed by the control system, wherein a cleaning programme contains a particular kind of cleaning of the items to be cleaned. The control system may comprise particularly at least one data processing apparatus.

In this context, a modular control system within the context of the present invention can be intended to be understood to mean a control system which comprises a plurality of elements which, although able to interact, are essentially able to perform their functions independently of one another. By way of example, these elements may be in a distributed arrangement and/or associated with functional units and/or loads in the cleaning apparatus. As an alternative or in addition to a preferred distributed arrangement, however, these elements may also be completely or partly combined in a single three-dimensional physical unit or in a plurality of physical units. Furthermore, likewise as an alternative or in addition, single instances or a plurality of the cited elements of the modular control system may be fully or partly produced as software components. In one conceivable variant, for example, there may thus be individual or a plurality of control elements of the modular control system produced as programme portions of a superordinate control programme. This variation can arise, by way of example, if the functionality of the modular control system were completely or partially stored in a PLC or a comparable installation and preferably only simple electronic switches were used for switching. As before, however, there needs to be a functional independence for the elements of the modular control system within the context of the above definition.

The modular control system can comprise a machine control system and at least one contactless control element. In this context, a machine control system is understood to mean the topmost level of the modular control system, which controls the programme cycle(s) of the cleaning apparatus for example. The machine control system, which, taken individually, may be of central or else of distributed design, may comprise, by way of example, a data processing apparatus, for example a computer. In addition, the machine control system may comprise, by way of example, at least one interface for interaction with a user and/or with external apparatuses, for example at least one screen, at least one operator control element and/or at least one other kind of interface.

Within the context of the present invention, a contactless control element can be intended to be understood to mean an apparatus which can be connected to a power supply, for example one or more power supply lines, and which has at least one output which can be used to provide a variable energy. By way of example, it may be possible for a variable power to be provided at the at least one output.

In this case, the variability may be stepless, in particular, so that, by way of example, between a minimum value, which may also be zero, and a maximum value, which corresponds to the value of the power supply, for example, an output power can be provided steplessly, which may also include the provision of a voltage, a current or another kind of energy. In this context, stepless is intended to be understood to mean a variable adjustment capability in which preferably no discrete levels are prescribed. Accordingly, the energy can be provided in analogue fashion, for example. Alternatively, however, it may also be provided in digital fashion, in which case preferably the resolution is chosen to be of such a level that over the bandwidth of the entire adjustment capability there are preferably at least 5, particularly at least 10 and particularly preferably at least 100 or more levels.

The contactless control element is also in a form such that it has a dedicated control system. This control system is intended to be externally influenceable, and in line with this control system, the aim is for the provided output power of the contactless control element to be adjustable. In particular, this control system of the contactless control element may have dedicated intelligence, for example a data processing apparatus, such as a controller, particularly a microcontroller. In addition, the control system of the contactless control element may comprise at least one memory element, particularly a volatile and/or non-volatile memory element. In addition, the contactless control element may have at least one connection to the outside, particularly an interface which can be used to influence the control system of the contactless control element. However, this influencing is intended to be effected such that the contactless control element can also operate autonomously, within the context of the modularity concept described above. Accordingly, it is not constantly necessary for the contactless control element to be influenced from the outside, but rather the contactless control element is set up to adjust the provided power autonomously without the need for additional elements in order to do so.

As illustrated above, the machine control system can be set up to perform at least one cleaning programme. The contactless control element is, as illustrated, set up to supply at least one of the loads with energy on a variable basis. In particular, the contactless control element may be connected to a power supply and may have at least one output at which the variable energy is provided for the at least one load. As illustrated above, variable may, in particular, be intended to be understood to mean stepless adjustability, with analogue or else finely stepped digital adjustability being able to be provided, for example.

As illustrated above, the cleaning apparatus can comprise at least two loads. In this case, each of the loads may have an associated contactless control element, or just some of the loads or one of the loads. The contactless control element may be in a distributed arrangement, for example, at the location of the load. However, the contactless control element preferably does not form part of the load itself, but rather forms an autonomous unit, regardless of the functionality of the load, which may be connected upstream of a power supply input of the load, for example. This provides a way of easily interchanging the loads and/or easily extending the cleaning device by one or more additional loads.

The machine control system can be set up to provide at least two different actuation strategies for the cleaning apparatus. In this case, each actuation strategy contains information about required energies for the loads, that is to say all loads in the cleaning apparatus or at least some loads in the cleaning apparatus or at least one load in the cleaning apparatus. An actuation strategy is thus intended to be understood, generally, to mean a plan for how energies can be distributed to all loads in the cleaning apparatus or at least for a group of at least two loads in the cleaning apparatus. In this context, the at least two actuation strategies can be chosen automatically, for example, by the machine control system, for example in line with a prescribed programme of the machine control system which generates these actuation strategies, or can also be selected, for example from a plurality of actuation strategies stored in a data memory. The actuation strategies can also be set or selected manually or automatically from the outside, for example by a user.

Each actuation strategy may correspond to a particular operating state of the cleaning apparatus, for example, that is to say to any state of the machine which is characterized by a set of adjustment parameters. Accordingly, at least two different operating states may be provided, that is to say at least two possible settings and/or procedures for the cleaning apparatus which are defined by means of a set of operating parameters, for example, and which have a respective associated actuation strategy. Each actuation strategy contains information about the required energies for the loads, that is to say about powers and/or voltages and/or currents which need to be provided for the respective loads, for example. In this case, this information is not yet the actual provision of power, but rather is merely intended to allow the contactless control element or the contactless control elements to perform the actual provision of power. Accordingly, the required energies can be indicated in absolute values or in relative units, that is to say in any units which allow inference of the energy which needs to be provided for the individual loads.

The machine control system can be set up to transmit the information about the required energies, that is to say about the required voltages and/or powers and/or currents for the associated loads, for example, to the contactless control elements via at least one bus system in line with a currently selected actuation strategy. This means that a current actuation strategy is selected from the plurality of actuation strategies which can be provided and the required energy is transmitted to the at least one contactless control element via the at least one bus system in line with the selected actuation strategy. In this case, a bus system is intended to be understood to mean a fundamentally arbitrary system for data transmission between a plurality of subscribers via a common transmission path, wherein preferably the respective subscriber is not involved in the data transmission between other subscribers. In particular, the bus system may comprise at least one CAN bus. A CAN bus is an asynchronous serial bus system which has been developed particularly for automotive technology. In principle, however, it is also possible to use other kinds of bus systems, particularly field bus systems. The bus system may preferably be completely hardware-implemented by virtue of one or more fixed or variable connecting lines or other physical connections being used, for example, wireless connections. As an alternative or in addition, the bus system may also be entirely or partially software-implemented, however, and may be entirely or partially replaced by one or more software programs.

The machine control system thus selects an actuation strategy, and uses the at least one bus system to transmit the information about the respective required energies for the associated loads to the at least one contactless control element. By way of example, as illustrated above, each load or a group of loads may have a respective associated contactless control element. Preferably, there is a one-to-one association, that is to say an association in which the at least one load has precisely one contactless control element. In this case, the information about the required energies for this load can be made available to all contactless control elements, or in each case only to the contactless control element of the respective load.

The contactless control element can be set up to take this information as a basis for applying the respective required energy, that is to say a required voltage and/or a required power, for example, to at least one associated load. In this case, an associated load is intended to be understood to mean at least one load which is associated with the contactless control element, for example by virtue of appropriate wiring using at least one power supply wire. Another connection for providing the required energy is also conceivable.

In summary, the embodiment of the cleaning apparatus may thus be such that a group of loads is provided. In this case, at least one of these loads, preferably a plurality of loads, has at least one respective associated contactless control element. The machine control system, which is set up to provide at least two different actuation strategies for the cleaning apparatus, selects an actuation strategy and uses the bus system to transmit the information about the required energies for the associated loads to the at least one contactless control element. Accordingly, the contactless control element ensures that the required energy is provided for the respective associated load.

The actuation strategies may in this case be designed such that a prescribed maximum total power of the cleaning apparatus or of a group of loads in the cleaning apparatus is not exceeded. This maximum total power may be thoroughly prescribed, but may also be variable. By way of example, the maximum total power may be stored permanently in the cleaning apparatus, for example in the modular control system, particularly the machine control system, but may also be prescribed externally, for example, via an interface to the machine control system. This opportunity for prescribing the maximum total power externally also allows or favours the incorporation of the cleaning apparatus into a more complex system with a plurality of apparatuses, for example into an energy management system, for example in a hospital, a care facility, a canteen in a company, an authority or the like.

As illustrated above, the contactless control elements may be connected to at least one power supply in order to set an energy which is applied to the respective associated load in line with the selected actuation strategy provided by the machine control system, or in line with the information contained in said actuation strategy about the required energies for the associated load. The at least one contactless control element may in this case fundamentally comprise any apparatus which is capable of meeting the demands of the stated kind. In particular, the contactless control element may comprise one or more of the following apparatuses: a thyristor; a triac; a stepless electronic relay.

The loads in the cleaning apparatus may, as illustrated above, be of diverse design. In particular, the loads may comprise one or more of the following elements of the cleaning apparatus: a heating element; a drive of a transportation apparatus for transporting items to be cleaned through the cleaning apparatus; a motor, particularly a pump motor and/or blower motor; a heat pump; a vapour generator; a valve, particularly a proportional valve. By way of example, the at least one heating element may comprise at least one tank heater and/or at least one continuous-flow heater and/or at least one boiler. By way of example, the at least one valve, particularly the proportional valve, can control a supply of at least one medium, for example a vapour and/or a liquid.

The at least one contactless control element, preferably the plurality of contactless control elements, may have dedicated intelligence, in particular as illustrated above. Accordingly, each contactless control element may respectively comprise at least one actuation controller. In this context, an actuation controller is fundamentally intended to be understood to mean a data processing apparatus which is capable of determining various actuation schemes for providing the required energies in line with the information about the required energies, for example by means of an appropriate software device.

In this context, an actuation scheme can be understood to mean a command set and/or a parameter set which is used by the contactless control element in order to provide the required energy which corresponds to this command set and/or parameter set. By way of example this may be at least one voltage which is used to actuate a thyristor and/or triac and/or an electronic relay in order to provide the required energy. While an actuation strategy thus fundamentally contains only information about the required energies for the individual loads or for the at least one load, the actuation scheme is thus the specific technical implementation which is used to provide the respective required energy via the at least one contactless control element.

The specific embodiment of the actuation schemes may be dependent on the technical implementation of the contactless control element. By way of example, an actuation scheme may, as illustrated above, include a command set and/or a parameter set, for example, voltages or the like. In particular, the actuation schemes may be set up to adjust the required energies using a steplessly adjustable method, for example using impulse-pause variation and/or using forward phase variation and/or using pulse width modulation.

Impulse-pause variation, which is frequently also called pulse-pause modulation, is intended to be understood to mean a coding method for analogue values. In this case, an analogue variable in the form of a pause duration between two impulses is coded. The pulses may in particular be of the same level and the same duration. A temporal fixed sampling rate is not necessary in this case.

Forward phase control is intended to be understood to mean a method for power control for an electrical load, wherein the electrical power is provided in the form of an AC voltage. In particular, the forward phase control can be controlled by a triac, that is to say an element with antiparallel connection of at least two thyristors. The forward phase control involves the current being switched on with a delay after a zero crossing by the AC voltage and then being applied usually until the next zero crossing. Alternatively, it is also possible to use reverse phase control, wherein a current is switched on immediately after the zero crossing and is switched off before the next zero crossing. This is likewise intended to be covered by the concept of forward phase control.

Within the context of the present invention, pulse width modulation can be understood to mean a method for power control for one or more electrical loads in which a technical variable, for example, an electrical current, alternates between two values. In this case, a duty ratio is varied at constant frequency. The resulting technical variable may then correspond particularly to the arithmetic mean and hence to the mean level of the surface below the modulated variable.

An advantage of the cited control and/or modulation types is that energies can be provided steplessly, for example powers steplessly, so that flexible control and flexible reaction to prescribed actuation strategies are possible, including two actuation strategies for which no actuation schemes have been known to date.

The contactless control elements may be set up to determine the actuation schemes autonomously, for example using an appropriate programme which is executed on the actuation controller. As an alternative or in addition, the contactless control elements may also have at least one memory with a plurality of stored actuation schemes, however, each actuation scheme corresponding to a required amount of energy.

It has already been illustrated above that an actuation strategy may correspond to an operating state, for example. In this case, however, the actuation strategy denotes the energies which need to be provided for the individual loads or for a group of loads in the cleaning apparatus, whereas the operating state denotes the state which is actually brought about thereby (possibly after an adjustment time has elapsed) for the cleaning apparatus or for individual elements of the cleaning apparatus. The operating state may, in particular, be defined by one or more of the following parameters: a mode of operation of the cleaning apparatus (for example a pre-wash mode, a main-wash mode, a rinse mode or a drying mode), a cleaning programme (for example intensive cleaning, normal cleaning or an economy cleaning programme), a loading with items to be cleaned (for example on the basis of light loading, average loading or heavy loading, or a type of items to be cleaned), an externally available power, particularly an available total power; specific hardware equipment of the apparatus or combinations of the cited and/or other parameters.

As illustrated above, the actuation strategies may include the information about the required energies for the loads in different ways, for example in absolute or in relative units. In this case, this information may respectively also comprise a significance in recognizable or coded form, for example one or more of the following parameters: a target temperature particularly a target temperature for cleaning fluid and/or a tank temperature; an amount of cleaning fluid, particularly an amount of water and/or art amount of a vapour; a transportation speed for transportation of items to be cleaned through the cleaning apparatus; loading of the cleaning apparatus with items to be cleaned; an amount of exhaust air.

The cleaning apparatus may also be designed such that the modular control system comprises at least one power sensing unit. This power sensing unit may be connected to the machine control system via the bus system, for example. In this case, the power sensing unit may be set up to sense a power drawn by the cleaning apparatus, particularly a total power. The power sensing unit may be configurable, in particular, that is to say externally influenceable, for example via at least one interface, particularly via a user interface and/or an interface to the machine control system, for example via the bus system.

In particular the power sensing unit may have at least one safety function. Accordingly, the power sensing unit may be set up, in particular, to transfer the cleaning apparatus to a safe state if the sensed power drawn exceeds a prescribed or prescribable maximum value. By way of example, the stipulation of this maximum value may be part of the possible configuration of the power sensing unit. By way of example, this maximum value may be a maximum value for the power drawn by the cleaning apparatus. This may be the total power drawn by the cleaning apparatus or just a portion of the power drawn which can be sensed separately, for example a portion of a particular group of loads in the cleaning apparatus.

By way of example, the safe state may comprise a function with a prescribed minimum power level for all or some loads. As an alternative or in addition, the safe state may also comprise an emergency off, for example, however, for example return of the drawn power to zero or a prescribed minimum power level. Accordingly, within the context of the safety function, for example, it is possible for single or all loads to be switched off. For this purpose, the power sensing unit may be connected to an emergency-off circuit of the cleaning apparatus, for example, so that an output of the power sensing unit, for example, can switch off the whole cleaning apparatus without requiring intervention in the operation of the cleaning apparatus. Accordingly, the power sensing unit can bring about the safe state, for example, by bypassing the machine control system, for example using the emergency-off circuit. The power sensing unit and/or the emergency-off function thereof may also be of redundant design, for example by virtue of duplicate hardware for the power sensing unit itself or by virtue of combination with additional line protection elements, for example line protection switches such as fuses. Accordingly, there may be a two-channel embodiment, for example.

The machine control system may also be set up to perform at least one learning mode. In this learning mode, at least one element of the cleaning apparatus, particularly at least one load and/or an actuator, is actuated. The machine control system is in this case set up to store the power sensed by the power sensing unit. By way of example, this stored power may be significant when at least one actuation strategy is produced, for example. Thus, by way of example, the machine control system can compile an actuation strategy from the stored powers, with a power scheme being produced for a prescribed maximum power and/or an operating state, for example, wherein the desired functions of the cleaning apparatus are performed wherein at the same time a prescribed maximum value of the drawn power is not exceeded for example. Such learning programmes are known in principle, for example from DE 10 2007 032 053 A1 cited above, wherein such programmes can now be used as part of the modular control of the cleaning apparatus in order to produce autonomous actuation schemes. As an alternative or in addition, however, these actuation schemes can, as illustrated above, also be produced and, by way of example stored, entirely or partially manually. The use of the stored powers from the learning mode is a particularly efficient way of reacting to the actual circumstances of the cleaning apparatus and producing appropriately customized and realistic actuation strategies.

Furthermore, as an alternative or in addition, the at least one power sensing unit can be used for further purposes. By way of example, the machine control system may thus be set up to take the power sensed by the power sensing unit and/or a change in the sensed power, for example a temporal change over a prescribed period, and infer at least one state for at least one element of the cleaning apparatus, particularly at least one load and/or an actuator. This makes it possible to infer wear on a particular element of the cleaning apparatus and/or calcification of an element, for example, and/or another kind of degradation of this element.

As already indicated above, the actuation strategies may be embodied in different ways. In particular, these actuation strategies may include information about an energy distribution of the loads or one or more groups of loads in the cleaning apparatus. In this case, it is also possible for at least one of the actuation strategies to be set up to switch on or switch off at least one functional group of the cleaning apparatus. In this context, a functional group is a part of the cleaning apparatus which comprises a plurality of elements of the cleaning apparatus, particularly a plurality of loads and/or actuators. Examples of functional groups are particular cleaning stations and/or particular drying systems and/or particular provision devices for cleaning fluids, for example vapour and/or cleaning liquid. By way of example, it is thus possible for a boiler or a continuous-flow heater to be switched off completely.

A particular advantage of the modular design of the control system for the cleaning apparatus is that the modular control system can be incorporated into an external energy management system and/or can interact with such an energy management system, for example unidirectionally or bidirectionally. Accordingly, the modular control system, particularly the machine control system, may be set up to interact with an external energy management system, particularly to interact bidirectionally. Accordingly, the machine control system may be set up to take this interaction as a basis for providing an actuation strategy, for example to select it from a plurality of actuation strategies and/or to produce it autonomously. By way of example, autonomous production may involve a maximum power for the cleaning apparatus, as prescribed by the energy management system being shifted to a power draw by individual elements, for example individual loads, of the cleaning apparatus, for example on the basis of a prescribed key. More complex or other algorithms for producing the actuation strategy are also conceivable. By way of example, the modular control system can therefore have stipulations applied to it unidirectionally, for example, by the energy management system, and/or the modular control system, for example the machine control system, can inquire with the energy management system in order to obtain particular stipulations, for example a maximum power. By way of example, the modular control system may comprise at least one communication module in order to interact with the energy management system.

Besides the cleaning apparatus in one or more of the embodiments described above, the invention also describes a method for controlling a cleaning apparatus for cleaning items to be cleaned. In particular, the method can be performed using a cleaning apparatus according to one or more of the implementations described above. Accordingly, it is possible to refer to the above description for optional embodiments. The cleaning apparatus comprises at least two loads. The cleaning apparatus also comprises a modular control system with a machine control system and at least one contactless control element. The machine control system can perform at least one cleaning programme, and the contactless control element can supply at least one load with energy on a variable basis. The machine control system is set up to provide at least two different actuation strategies for the cleaning apparatus. In this context, each actuation strategy comprises information about required energies for the loads. The machine control system transmits information about the required energies for the associated loads to the contactless control elements via a bus system in line with a selected actuation strategy, wherein the contactless control element applies the respective required energy to at least one associated load. For further possible embodiments and definitions, reference can be made to the above description.

The cleaning apparatus described above and the method have a multiplicity of advantages over known apparatuses and methods of this kind. Thus, the presented approach follows the principle that scaling/variation on the cleaning apparatuses allows particular machine elements, such as one or more wash tanks, a rinsing system, one or more drying systems or similar elements or expansion stages of machine elements, should be associated with the machine control system specifically with regard to heating and motor power. In this context, these are not all determined on the basis of the installed power or by the prescribed method, or required in full at one time. By way of example, it is thus possible to actuate heating elements using contactless control elements. The machine control system can supply these contactless control elements with information about the required flow of energy via the bus system, for example, the CAN bus. In this case, the contactless control elements can be designed such that actuation schemes stored thereon, for example impulse-pause variations or forward phase combinations or pulse width modulations, are used which allow the energy requirement to be supplied in optimum fashion, depending on the demanded power, for example heating power, and the instance of application. In this case, it is also possible to store a plurality of principles on the contactless control element and to select them specifically according to requirements, for example via the bus system. Instances of application may be the heating power for heating the tank water, the rinsing water and/or the drying system. The actuation strategies provided in the machine control system and from which one actuation strategy is selected, for example in line with a desired operating state and/or a wash programme and/or a method and/or a machine scaling and/or external stipulations, communicate with the contactless control elements via the bus system, for example the CAN bus. This can be done such that both a state of regulators and the method and/or scaling of the cleaning apparatus itself determines the level of the required power. Conventional control elements, such as contactors or simple contactless switching elements, cannot follow this intelligent communication of machine control system and variable energy transmission, using at least one intelligent contactless control element. The actuation strategies may comprise complete power schemes which can be stored in the machine control system or generated in the machine control system. The cleaning apparatus is therefore, as far as its actuators and the energy requirement thereof are concerned, for example, electronically scaleable. It would accordingly also be possible to scale a cleaning apparatus, in line with the actuation strategies, in situ, for example in line with the requirements and using stored actuation strategies.

The actuation strategies can therefore be tuned in optimum fashion, for example to a mode of operation, a wash programme, a loading, to an available power or a piece of hardware. The actuation strategies may include parameters, such as target temperatures, amounts of water, speeds or loading of the cleaning apparatus. The loading can, under certain circumstances, have significant influence on the energy requirement of the cleaning apparatus. As a result of their defined constraints, the power schemes, which can be prescribed by the manufacturer, usually form the certainty for a process which is perfect in terms of hygiene or safety engineering. By way of example, an appropriate selection of an actuation strategy allows a prescribed action to be attained, for example a cleaning and/or disinfecting action. This can be done on the basis of the Sinner circle, for example, that is to say a mechanism of action which can be used to organize and perform cleaning cycles. This allows cleaning factors of the cleaning apparatus, such as chemistry, mechanics, temperature and time, particularly the application time, to be tuned to one another, so that a prescribed cleaning action is obtained. By way of example, an actuation strategy can be taken as a basis for cutting back one or more of the cited factors in favour of other factors, or vice versa. By way of example, it is possible to use weaker chemicals or less concentrated chemicals, with an application time simultaneously being increased. On the other hand, it is possible to reduce a heating power, for example with simultaneously higher doses of chemicals, for example higher dosage of cleaning concentrate. In this way, the manufacturer is able to prescribe actuation strategies, which, as a result of their defined constraints, assure the certainty of a process which is perfect in terms of hygiene or safety engineering.

In consideration of these parameters in the power schemes, firstly statically and secondly dynamically, the individual contactless control elements can be connected or disconnected when the load power, for example, heating power, is not required or is required only in part in the available actuation strategies. The resultant power reserve can be calibrated using the machine control system and the selected actuation strategy and can be associated according to requirements, for example with other loads or contactless control systems, and/or dispensed with completely. In addition, it is possible, by way of example, to use suitable selection of an actuation scheme, for example to use a suitable impulse-pause variation and/or forward phase combination, to provide energy for the relevant functional units, particularly the loads, after a time lag, using the actuation scheme, for example a stored actuation scheme. This makes it possible to ensure that the total power, which can be prescribed externally, inter alia is not exceeded.

The total power can be measured by the power sensing unit, for example at a central location. By way of example, the power sensing unit may be connected to the machine control system, particularly to a central computation unit of the machine control system via the bus system, for example the CAN bus. The power sensing unit can therefore provide information, for example about a present power which is being drawn from the mains. The power prescribed by means of the contactless control elements or else other, motor, powers, are reflected in this measured value and can be used to monitor the maximum available power and also to control the possible power. In this case, the power sensing unit can be operated in different modes. Firstly, the total drawn power can be sensed in an operating mode. Secondly, individual actuators can be actuated by the machine control system in a type of learning mode, and the measured value sensed from the power sensing unit via the bus system can be stored in the control system for later use. The thus ascertained database for the loads, such as motors, heating powers, actuators, but also complete units, can be used for various purposes. By way of example, the measured values allow predictive creation of energy requirements for the various modes of operation, programmes or scalings which can be found in the actuation strategies and/or which can be used for producing the actuation strategies. As an alternative or in addition, a suitable database for economic calculations and/or evaluation strategies can be provided inexpensively.

Furthermore, as an alternative or in addition, it is also possible to use a possibly changed power draw to make inferences about impairment of particular elements, for example wear and/or calcification. It is known that calcified heating elements, for example, require more time to heat the amount of water than non-calcified elements. Thus, changes in the power draw in the case of pump motors, for example, indicate an alteration on hydraulic elements. By way of example, this allows blocked nozzles and/or missing wash systems to be detected and/or alterations on pump impellers to be recognized. Known approaches firstly measure the energy consumed directly on the actuators or start from a value ascertained using external meters or theoretically. In the first case, detection of impairments can be implemented only in comparatively complex fashion on account of one sensing system being respectively required per actuator. In the second and in the third cited case, alteration or impairment of the elements during the running time, caused as described above, cannot be determined or can be determined only scarcely. By contrast, the proposed system with the relevant power sensing unit and the machine control system can be used to perform such diagnosis easily.

The modular control system, particularly the machine control system and/or the data processing apparatus thereof, may therefore be set up to customize the available power in optimum fashion to the process requirements and the physically present constraints. In this case, the customization may be effected such that the defined maximum power, which may be prescribed by installation engineering and/or an energy optimization system, for example, is not exceeded. This function can be performed particularly by the power measurement integrated in the modular control system using the power sensing unit.

The proposed actuation strategies can be used to connect or disconnect entire functional groups, it is also possible for reduced load powers, for example heating powers, to be impressed on the process, particularly by impulse-pause variations and/or forward phase combinations. By way of example, this can be done such that specific wash programmes and/or scalings do not or only partially supply the functional units and/or one or more of the available functional units of the cleaning apparatus with energy. With suitable equipment of the machine elements and/or stipulation of the actuation strategies, it is thereby possible for machine elements to be prefabricated on a modular basis and/or to be electronically customized and/or scaled to the power requirements in situ, at least to a certain extent.

A further approach which can be taken within the context of the cleaning apparatus described above is to redistribute a weighting for the individual loads, at least to a certain extent, on the basis of the Sinner circle, without thereby influencing a cleaning action to a significant degree. In the absence of heating power or if there is just a small amount of heating power or a small amount of energy, for example, it is thus possible to use a transportation speed to influence an application time. By way of example, it is thus possible, at least to a certain extent, to achieve the same cleaning effects and/or disinfecting actions at reduced target temperatures and hence reduced required heating power, for example the same number of heat equivalents. As illustrated above, the Sinner circle is an explanatory model in this context in which, for the cleaning of tableware, for example, four factors play a significant part, namely chemistry, mechanics, temperature and application time. These factors are represented in the form of a circular chart in the Sinner circle. On the basis of this approach, it is possible for temperatures and hence heating power or transportation speed and hence application time to be redistributed within a certain framework without thereby altering the cleaning result. This redistribution can easily be implemented within the context of the flexible actuation strategy using the various actuation schemes.

As illustrated above, the control system also provides the opportunity to interact with external energy management systems, for example with external energy optimization systems. Thus, by way of example, the cleaning apparatus provides the opportunity to accept maximum power demands from superordinate energy optimization systems. The invention presented above can be used to allocate the available resources in optimum fashion. This can be done by means of intelligent connection and/or disconnection of the power for individual loads, for example. By contrast, earlier approaches disconnect the power usually unconditionally without consideration for hygiene-related demands by the cleaning apparatus, for example. On the other hand, by way of example, the intelligent tuning with an external energy management system, for example an energy optimization system, allows integration of the cleaning apparatus, for example a dishwasher, into an overall system of an external energy management system, for example into an overall system of an energy provision system in a house. This integration can be effected economically and while observing all hygiene-related regulations at the same time. By way of example, upon consultation with an operator and/or chef, the control system can either select a different actuation strategy, when there is reduced energy availability, or else can deny the demand for a power reduction to the superordinate energy optimization installation, for example.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exemplary embodiment of a modular control system;

FIG. 2 shows an exemplary embodiment of a contactless control element; and

FIG. 3 shows an exemplary embodiment of a cleaning apparatus according to the invention.

### DETAILED DESCRIPTION

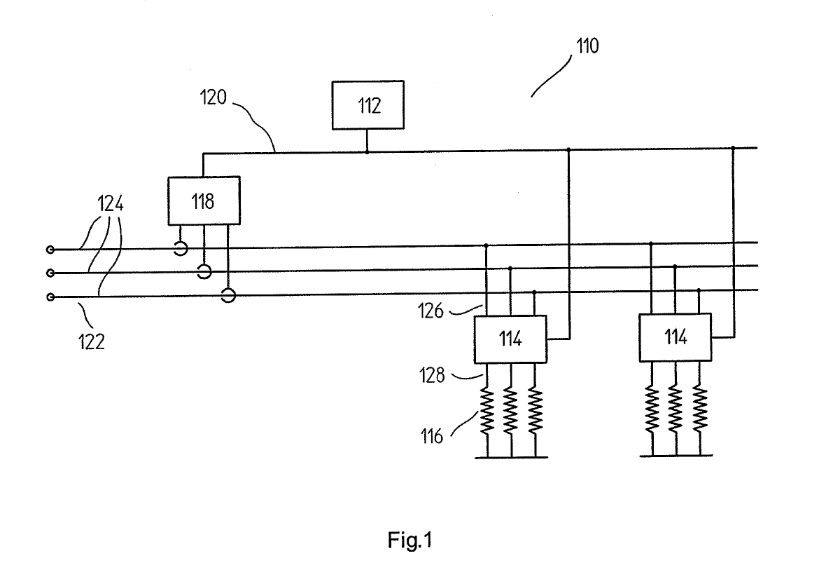

FIG. 1 shows an exemplary embodiment of a modular control system 110 for use in a cleaning apparatus. The modular control system 110 comprises a machine control system 112, which may comprise a data processing apparatus and/or at least one electronic memory, for example. In addition, the modular control system 110 in the exemplary embodiment shown comprises a plurality of contactless control elements 114 which, in the exemplary embodiment shown, are respectively associated with one or more indicated loads 116. In this case, the loads 116 are usually not themselves part of the modular control system 110.

Furthermore, the modular control system 110 in the exemplary embodiment shown comprises a power sensing unit 118. The power sensing unit 118, the machine control system 112 and the contactless control elements 114 are connected via a bus system 120, which in this exemplary embodiment may be in the form of a CAN bus, in particular.

As already stated above, the bus system 120 may be fully or partially implemented in hardware, for example as a CAN bus. As an alternative or in addition, however, it may fundamentally also be reduced to a minimum or even also fully or partially produced in virtual form, i.e. in software-implemented form. This bus system 120 may thus involve a simple connection, for example.

Accordingly, the elements of the modular control system 110 may be arranged entirely or partially in a distributed manner, that is to say at different locations. As an alternative or in addition, it is also possible, as stated above, for a plurality of or even all elements of the modular control system, for example the machine control system 112 and the contactless control elements 114 and optionally the power sensing unit 118, to be combined in one environment, for example on a board, and with the aim of continuing to maintain functional independence of these elements for the modularity concept described above. In addition, the elements of the modular control system 110, for example the machine control system 112 and the contactless control elements 114 and optionally the power sensing unit 118, may also entirely or partially, individually or in numbers or even all together be of software-implemented design, for example as modules of a superordinate programme, as an alternative to a preferred pure hardware implementation.

In addition, FIG. 1 shows a power supply 122 in the illustrated exemplary embodiment. By way of example, this power supply 122 may be a central power supply for a cleaning apparatus and is not necessarily part of the modular control system 110.

In the illustrated exemplary embodiment, the power supply 122 is equipped with a plurality of power supply lines 124, for example three power supply lines 124, which are denoted by L1, L2 and L3 in FIG. 1.

By way of example, the power sensing unit 118 can be used to sense a power drawn by the cleaning apparatus, particularly a total power, which is provided via the power supply 122. It should be pointed out that the power sensing unit 118 can also monitor just some of the power supply 122, for example just some of the power supply lines 124. By way of example, the monitoring can be performed using ammeters and/or voltmeters which are known to a person skilled in the art.

The contactless control elements 114 may each have one or more inputs 126 which are connected to the power supply 122, for example to one, a plurality or all of the power supply lines 124. This allows the contactless control elements 114 to be provided with an energy, for example a maximum available energy. In this case, the concept of energy also covers the concept of a power within the context of the present invention. The contactless control elements 114 are set up to provide a required energy for the loads 116 on a variable basis via one or more outputs 128.

Via the bus system 120, each contactless control element 114 receives from the machine control system at least one piece of information about the required energy for the associated loads 116. The variable provision of the energy at the outputs 128 is effected in line with this at least one piece of information.

It should be pointed out that the modular control system in FIG. 1 is shown only in highly schematic form. There may be one, two or more contactless control elements 114 provided. Further optional control elements and/or input/output units are not shown in FIG. 1. In addition, the loads 116 in FIG. 1 are symbolically in the form of heating elements. Another embodiment of the loads 116 is also fundamentally possible as an alternative or in addition, however.

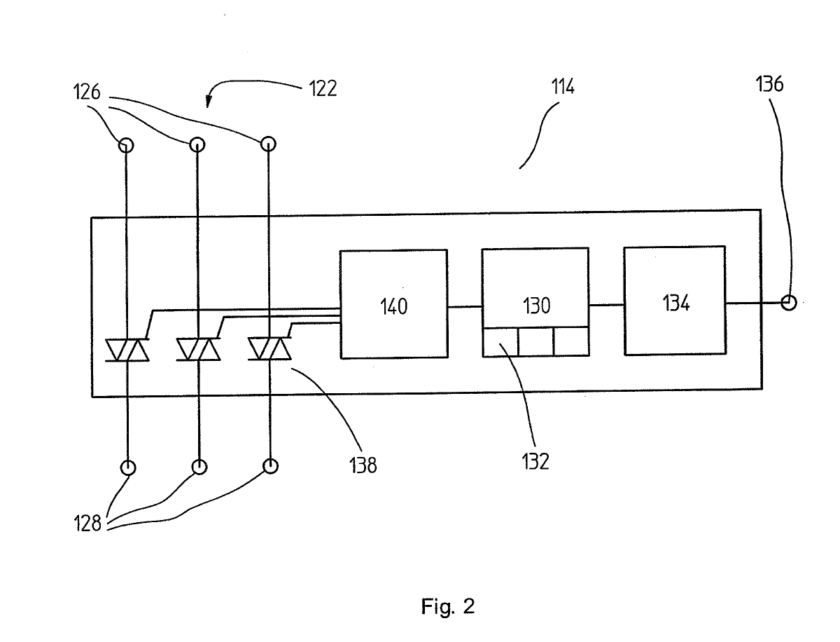

FIG. 2 shows schematically an exemplary embodiment of a contactless control element 114, as might be used in the exemplary embodiment of the modular control system 110 shown in FIG. 1, for example. The contactless control element 114 can also be used in other exemplary embodiments, however, or other types of contactless control elements 114 might be used in the exemplary embodiment of the modular control system 110 shown in FIG. 1.

The contactless control element 114 from FIG. 2 preferably comprises dedicated intelligence. In this exemplary embodiment, said intelligence is provided by an actuation controller 130, for example an actuation controller 130 having a data processing apparatus, such as a microcomputer. In addition, the contactless control element 114 may comprise one or more data memories 132, which may be part of the actuation controller 130, for example, as indicated in FIG. 2. This data memory 132 can store one or more actuation schemes, for example, as stated in more detail below.

The actuation controller 130 may have a communication chip 134 connected to it which in turn may be connected to a connection 136 for connection to the bus system 120 (not shown in FIG. 2).

In addition, the contactless control element 114 has at least one input 126 and at least one output 128. The input 126—the illustrated exemplary embodiment being provided, by way of example, with three inputs, for example for connection to the power supply lines 124—may be connected generally to the power supply 122. The output 128 may be connected to one or more loads 116—not shown in FIG. 2—which are associated with the contactless control element 114.

In addition, the contactless control element 114 in this or else in other exemplary embodiments preferably comprises one or more variable adjustment elements which can be used to convert an input energy (which may also comprise an input power), provided at the input 126, into an output energy (which may also include an output power), which is to be provided at the output 128. By way of example, these variable adjustment elements 138 may be electronic switches which can preferably be set steplessly. By way of example, these electronic switches are what are known as triacs, that is to say semiconductor components which comprise an antiparallel connection of two thyristors. As an alternative or in addition, however, it is also possible to use other types of variable adjustment elements or electronic switches. A combination of different types of variable adjustment elements 138 is also possible.

The variable adjustment elements 138 can be actuated directly by the actuation controller 130 or, as indicated in FIG. 2, by additional and optional internal actuation electronics 140. By way of example, these internal actuation electronics 140 can provide control signals for the variable adjustment elements 138, for example appropriate voltages for controlling the triacs.

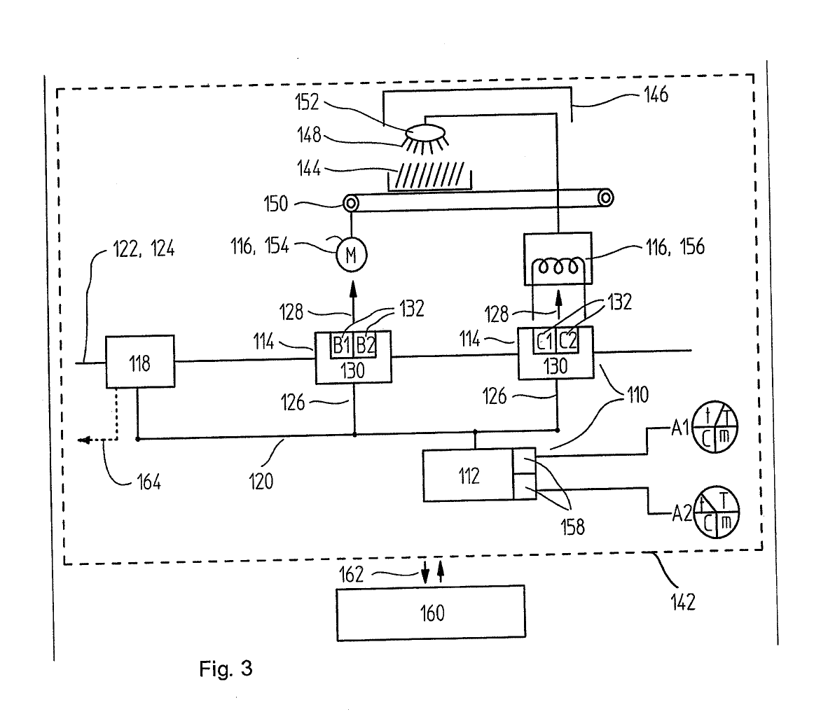

Finally, FIG. 3 shows an exemplary embodiment of a cleaning apparatus 142 for cleaning items to be cleaned 144. In this case, the cleaning apparatus 142 is shown only in highly schematic form. By way of example, the items to be cleaned 144 may be tableware, as indicated in FIG. 3. By way of example, the items to be cleaned 144 can have a cleaning fluid 148 applied to them in at least one cleaning chamber 146. In this case, there may be one or more cleaning chambers 146 provided. In the illustrated exemplary embodiment, a continuous-flow dishwasher is shown by way of example, in which the items to be cleaned 144 are transported through the one or more cleaning chambers 146 by means of a transportation apparatus 150. In this case, as indicated in FIG. 3, one or more cleaning systems 152 may be provided, for example spray nozzle systems. As an alternative or in addition, however, other types of cleaning systems 152 are also conceivable, for example vapour cleaning systems or cleaning systems in which cleaning and/or disinfection takes place generally, the concept of cleaning also being intended to cover purely thermal disinfection.

In addition, the cleaning apparatus 142 again comprises a modular control system 110 with a machine control system 112 and contactless control elements 114 and also a bus system 120 and an optional power sensing unit 118. For possible embodiments of the modular control system 110, reference can be made by way of example to the description of the above exemplary embodiments in FIGS. 1 and 2, but another embodiment of the modular control system 110 is also possible in principle.

The cleaning apparatus 142 comprises a plurality of loads 116. In this case, all or just some of these loads 116 can be actuated in the manner described below, that is to say can be incorporated into the modular control system 110. In addition, there may optionally be one or more loads 116 provided which are actuated in a conventional manner without the use of the method according to the invention.

The loads 116 are in turn intended to be supplied with a required energy via a power supply 122. For this purpose, the contactless control elements 114 are in turn provided, the outputs 128 of which are able to provide these loads 116 with energies in a variable fashion.

By way of example, FIG. 3 shows two loads 116, namely a drive 154 for the transportation apparatus 150, for example a motor, and a heating element 156. As an alternative or in addition, it is also possible for other types of loads 116 to be provided, reference being able to be made by way of example to the description above.

The machine control system is set up to provide at least two, preferably more than two, different actuation strategies. These actuation strategies are denoted symbolically in FIG. 3 by A₁ and A₂. By way of example, these actuation strategies can be provided by means of direct generation and/or by virtue of a plurality of actuation strategies being stored in a data memory 158, as indicated in FIG. 3. The data memory 158 may be part of the machine control system 112 or may also be arranged at another location in the cleaning apparatus 142, more particularly the modular control system 110. The machine control system 112 is set up to take the plurality of actuation strategies and select an actuation strategy which is currently intended to be used. By way of example, this selection can be made manually by a user, for example using an optional user interface—not shown in FIG. 3. As an alternative or in addition, however, the selection can also be made optionally by means of interaction with the external energy management system 160, for example via an interface 162. As illustrated above, this allows the cleaning apparatus 142 to be incorporated into a superordinate energy optimization system, for example. The external energy management system can, by way of example, transmit a maximum available total power, for example a total power for the power supply 122, to the cleaning apparatus 142. In line with this transmitted available total power, the machine control system 112 can select an actuation strategy, for example.

In this and also in other exemplary embodiments, the machine control system 112 may be set up, by way of example, such that a total power drawn by the cleaning apparatus 142 overall is altered, but a cleaning action for cleaning the items to be cleaned 144 remains the same. As indicated in FIG. 3, this can be effected in particular using what is known as the Sinner circle, which indicates the relationship between various cleaning factors. These cleaning factors are shown symbolically in FIG. 3. They include chemistry, denoted symbolically by the letter C in FIG. 3, that is to say a nature and/or concentration of a cleaning agent and/or of another chemical consumable in the cleaning fluid 148 (a plurality of cleaning fluids 148 also possibly being provided), for example, the mechanical action on the items to be cleaned, which is denoted symbolically by the letter m in FIG. 3 and which can be influenced by an embodiment of a cleaning jet which impinges upon the items to be cleaned 144, for example, the temperature T of the cleaning fluid 148 and also the application time t for the cleaning on the items to be cleaned 144.

It should be pointed out that this illustration is highly simplified and is merely used to clarify an exemplary embodiment of the invention. In more complex cleaning apparatuses 142, there may also be a plurality of factors provided in each segment of the Sinner circle. By way of example, a plurality of cleaning fluids 148 may be provided which may each contain a different type and/or concentration of chemistry. In addition, the plurality of cleaning fluids and/or also other types of cleaning media may also have different temperatures T. Accordingly, the action of a mechanical type may also be in multiple different forms, for example by virtue of different mechanical actions taking place in a plurality of chambers and/or cleaning systems 152 of the cleaning apparatus 142. In line with these different types of a plurality of actions, there may also be a plurality of periods t provided for these actions. However, a person skilled in the art is readily able, particularly by means of measurements, to ascertain the extent to which these segments of the Sinner circles interact and the extent to which, by way of example, an influencing factor or a segment of the Sinner circle needs to be increased if one or more other segments are lowered. By way of example, this can be done by means of measurements of a cleaning action, for example a visual cleaning action and/or, a hygienic cleaning action. The latter can be ascertained by means of contact examinations and/or other microbiological methods, for example. Other methods for measuring the cleaning action can also be used as an alternative or in addition.

FIG. 3 shows these processes symbolically by means of the two actuation strategies A₁ and A₂. In this case it may be assumed that these actuation strategies A₁ and A₂ have a cleaning action which is the same or which is similar at least within a tolerable discrepancy. However, actuation strategies with different cleaning actions may also be provided as an alternative or in addition. By way of example, the actuation strategies A₁ and A₂ differ in that in the actuation strategy A₁ a lower temperature is chosen, for example a lower temperature for the cleaning fluid 148, whereas the application time t is increased. By contrast, in actuation strategy A₂, the application time t is shorter, whereas the temperature is increased. The cleaning action of both actuation strategies A₁ and A₂ may be the same in this case, the cleaning action being able to be checked by means of a cleaning and/or disinfection result for the cleaned items to be cleaned 144 for example. This can be done using contact examinations on the items to be cleaned 144, for example. Such examinations are known fundamentally to a person skilled in the art.

By way of example, the machine control system 112 may be designed to take an available total power as a basis for first of all operating the cleaning apparatus 142 using the actuation strategy denoted by A₂. This actuation strategy A₂ involves a short application time t₂, which can be implemented by means of a high transportation speed for the transportation apparatus 150 for example, which may be in the form of a basket transportation apparatus (as shown in FIG. 3) or in the form of a belt transportation apparatus, for example. Accordingly, there is a high throughput of items to be cleaned 144.

If the machine control system 112 then receives the stipulation that the total power needs to be reduced, for example, with the cleaning action preferably needing to remain the same, then the machine control system 112 can then select the actuation strategy A₁, for example. This actuation strategy A₁ cuts back the temperature action, with the application time t being able to be increased in order to achieve a constant cleaning result. This can be done by means of a slower transportation speed for the transportation apparatus 150, for example.

The optional interaction between the machine control system 112 and the external energy management system 160 may be unidirectional or else bidirectional. Unidirectionally, it is possible to transmit only a stipulation to the machine control system 112, for example. Bidirectionally, it is possible for a request to be made to the external energy management system via the machine control system 112, for example, in order to inquire about constraints, particularly available total powers, for example. Other embodiments are also possible.

In addition, it should be pointed out that the two illustrated exemplary embodiments of the actuation strategies A₁ and A₂ show only one of many examples of the selection of these actuation strategies. Thus, further actuation strategies may also be provided, for example actuation strategies A₃, A₄, etc. In addition, in the illustrated exemplary embodiment, there is, by way of example, only interaction between the Sinner factors t and T. As an alternative or in addition, however, optionally there also may be interaction with the other factors and/or between the other factors, with an almost arbitrary selection of at least two of these factors which can interact with one another being possible. By way of example, it is thus possible to compensate for a relatively low temperature and hence a relatively low energy requirement for the machine with a higher concentration of a cleaner (that is to say influencing the factor C). This influencing can be effected by means of at least one valve control system for at least one metering valve, for example. Various embodiments are possible. In line with the selected actuation strategy, the machine control system 112 uses the bus system 120 to transmit information about the required energies for the associated loads 116 to one or more contactless control elements 114. In this case, all or just selected pieces of information, can be transmitted specifically to the associated contactless control elements 114, or all contactless control elements 114 can receive all of the information together. Various embodiments are possible.

The contactless control elements are set up to apply the energy respectively required for the selected actuation strategy to the associated loads 116 in line with the transmitted information. This application may be permanent or else just intermittent. For this purpose, the contactless control elements may be set up, by way of example, to determine actuation schemes for providing the required energies. By way of example, these actuation schemes can be generated by the actuation controllers 130. The actuation schemes can be selected from a data memory 132, for example, and/or else generated directly. The actuation schemes are denoted by B₁ and B₂ or C₁ and C₂ in FIG. 3 by way of example. In addition, further actuation schemes may be provided optionally in each case, for example B₃, B₄, etc. or C₃, C₄, etc. By way of example, a respective actuation scheme may be associated with an actuation strategy. By way of example, as explained above, in the case of the actuation strategy A₂ the contactless control element 114 which is associated with the heating element 156, can select an actuation scheme C₂ which involves the heating element 156 having a high heating power applied to it, for example by means of appropriate adjustment of a triac. At the same time, the contactless control element 114 allocated in the drive 154 can select an actuation scheme B₂ which likewise applies a high power or a resultant relatively high speed to the drive 154.

If the actuation strategy A₁ is then selected, as described above, the contactless control elements 114 accordingly can select the actuation schemes B₁ and C₁, in which a relatively low power or a resultant relatively low speed is applied to the drive 154 (corresponding to a relatively high transmit time t) in the same way as the heating element 156 has a relatively low heating power applied to it (corresponding to a relatively low application temperature T). As illustrated above, this is only one possible exemplary embodiment of the alteration of actuation schemes, however. On the basis of the description, it is a simple matter for a person skilled in the art to develop further exemplary embodiments.

In addition, FIG. 3 again shows the power sensing unit 118, which is set up to sense a power drawn by the cleaning apparatus 142, for example a portion of the total power or the total power. If the power drawn exceeds a prescribed maximum value, the power sensing unit 118 may be set up, by way of example, to perform at least one safety function, for example to operate an emergency off. This is indicated in FIG. 3 by the dashed arrow with reference numeral 164.

In addition, the power sensing unit 118 can also be used to perform a learning mode. Thus, the modular control system 110 can actuate particular loads 116 in the learning mode, for example, and test the influence on the power draw experimentally. This can be used for generating the actuation schemes and/or actuation strategies.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A cleaning apparatus for cleaning items to be cleaned, the cleaning apparatus comprising:
at least two loads; and
a modular control system having a machine control system and at least one contactless control element,
wherein the machine control system is configured to perform at least one cleaning program,
wherein the contactless control element is configured to supply at least one of the loads with energy on a variable basis,
wherein the machine control system is configured to provide at least two different actuation strategies for the cleaning apparatus,
wherein each actuation strategy comprises information about required energies for the loads,
wherein the machine control system is configured to transmit information about the required energies for the associated loads to the contactless control element via at least one bus system in line with a selected actuation strategy, and
wherein the contactless control element is configured to apply the respective required energy to at least one associated load.

2. The cleaning apparatus according to claim 1, wherein the actuation strategies are designed such that a prescribable maximum total power is not exceeded.

3. The cleaning apparatus according to claim 1, wherein the contactless control elements comprise one or more of the following apparatuses: a thyristor; a triac; and/or a stepless electronic relay.

4. The cleaning apparatus according to claim 1, wherein the loads comprise one or more of the following elements of the cleaning apparatus: a heating element; a drive for a transportation apparatus for transporting items to be cleaned through the cleaning apparatus; a motor or a pump motor and/or a blower motor; a heat pump; a vapour generator; and/or a valve or a proportional valve.

5. The cleaning apparatus according to claim 1, wherein the contactless control element respectively comprises at least one actuation controller, wherein the actuation controller is configured to take information about the required energies as a basis for determining actuation schemes for providing the required energies.

6. The cleaning apparatus according to claim 5, wherein the actuation schemes are set up to set the required energies using impulse-pause variation and/or forward phase variation and/or pulse width modulation.

7. The cleaning apparatus according to claim 5, wherein the contactless control element has at least one memory with a plurality of stored actuation schemes, wherein each actuation scheme corresponds to a required amount of energy.

8. The cleaning apparatus according to claim 1, wherein the bus system comprises at least one CAN bus.

9. The cleaning apparatus according to claim 1, wherein a respective actuation strategy is associated with an operating state, wherein the operating state is defined by one or more of the following parameters: a mode of operation of the cleaning apparatus; a cleaning programme; a loading with items to be cleaned; an available power and/or an available total power; and/or specific hardware equipment of the cleaning apparatus.

10. The cleaning apparatus according to claim 1, wherein the actuation strategies include one or more of the following parameters: a target temperature, particularly a target temperature for a cleaning fluid and/or a tank temperature; an amount of cleaning fluid, particularly an amount of water and/or an amount of a vapour; a transportation speed for transportation of items to be cleaned through the cleaning apparatus; a loading of the cleaning apparatus with items to be cleaned; and/or an amount of exhaust air.

11. The cleaning apparatus according to claim 1, wherein the modular control system comprises at least one power sensing unit, wherein the power sensing unit is connected to the machine control system via the bus system, wherein the power sensing unit is configured to sense a power drawn by the cleaning apparatus, particularly a total power.

12. The cleaning apparatus according to claim 11, wherein the power sensing unit has at least one safety function and is set up to transfer the cleaning apparatus to a safe state if the sensed power drawn exceeds a prescribed or prescribable maximum value.

13. The cleaning apparatus according to claim 11, wherein the machine control system is configured to perform at least one learning mode, wherein the learning mode involves actuation of at least one element of the cleaning apparatus, particularly at least one load and/or an actuator, wherein the machine control system is configured to store the power sensed by the power sensing unit in this case.

14. The cleaning apparatus according to claim 13, wherein the machine control system is configured to use the stored powers for producing the actuation strategies.

15. The cleaning apparatus according to claim 11, wherein the machine control system is configured to take the power sensed by the power sensing unit and/or a change in the sensed power and infer at least one state for at least one element of the cleaning apparatus, particularly at least one load and/or an actuator, particularly wear and/or calcification.

16. The cleaning apparatus according to claim 1, wherein at least one of the actuation strategies is configured to switch on or switch off at least one functional group of the cleaning apparatus, wherein the functional group comprises a plurality of elements of the cleaning apparatus, particularly a plurality of loads and/or actuators.

17. The cleaning apparatus according to claim 1, wherein the modular control system, particularly the machine control system, is set up to interact with an external energy management system, particularly to interact bidirectionally, wherein the machine control system is configured to provide an actuation strategy in line with said interaction.

18. A method for controlling a cleaning apparatus for cleaning items to be cleaned, the cleaning apparatus comprising at least two loads and a modular control system having a machine control system and at least one contactless control element, the method comprising:
providing via the machine control system at least one cleaning programme;
supplying via the contactless control element at least one of the loads with energy on a variable basis;
providing via the machine control system at least two different actuation strategies for the cleaning apparatus, each actuation strategy comprising information about required energies for the loads,
transmitting via the machine control system information about the required energies for the associated loads to the contactless control element via a bus system in line with a selected actuation strategy; and
applying via the contactless control element a respective required energy to at least one associated load.
